(19) United States
(12) Patent Application Publication
(10) Pub. No.: US 2026/0187498 A1
(43) Pub. Date: Jul. 2, 2026

(54) SYSTEM AND METHOD FOR EMPATHY PREDICTION USING RATER PERSPECTIVE

(71) Applicant: TOYOTA RESEARCH INSTITUTE, INC., Los Altos, CA (US)

(72) Inventors: Francine R. CHEN, Menlo Park, CA (US); Tatiana LAU, San Francisco, CA (US); Sumanta BHATTACHARYYA, Chicago, IL (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/003,608

(22) Filed: Dec. 27, 2024

(51) Int. Cl. G06N 5/04

(52) U.S. Cl. CPC G06N 5/04

(57) ABSTRACT

A method for empathy prediction using rater perspective is described. The method includes encoding a first story written by a first user regarding a selected topic to form a first embedding in an embedding space. The method also includes encoding a second story written by a second user regarding the selected topic to form a second embedding in the embedding space. The method further includes weighting the first embedding and the second embedding to from a weighted embedding in the embedding space. The method also includes predicting, by a trained classifier in response to the weighted embedding, a degree of empathy exhibited by the first user with respect to the second story according to the first story.

### BACKGROUND

### Field

Certain aspects of the present disclosure generally relate to machine learning and, more particularly, to a system and method for empathy prediction using rater perspective.

### Background

From behavioral science, it is recognized that empathy is “the ability to recognize, understand, and share the thoughts and feelings of another person, animal, or fictional character.” Although methods for empathy prediction have been proposed, most prediction is performed assuming that empathy can be predicted without consideration of different perspectives. Often, an aggregate of empathy ratings are used. Unfortunately, people will react with different levels of empathy to a given text passage, based in part on their background and current context. Additionally, stories by others with diverging views about an issue may be ignored or brushed aside because they are substantially different from a reader's own perspective.

Models for empathy prediction are generally developed from data labeled by third parties. For some situations, prediction of the average empathy towards a story, such as a political event, may be desirable; however, for other situations, individual empathy views may be important. Some examples include when negotiating a compromise with a person or comparing different ways of telling a story in hopes of gaining empathy. For example, when the same “story” is rated for empathy by different people, they assign different empathy scores based on their personal context. For example, someone that was a crime victim may be more empathetic to another crime victim. Conventional solutions instead assume that the empathy of a story can be predicted independent of a person assigned to rate the story (“rater”). Other works explore the use of demographics of a story writer as additional input, with mixed results. None of the approaches considers using the story of a rater when predicting empathy.

### SUMMARY

A method for empathy prediction using rater perspective is described. The method includes encoding a first story written by a first user regarding a selected topic to form a first embedding in an embedding space. The method also includes encoding a second story written by a second user regarding the selected topic to form a second embedding in the embedding space. The method further includes weighting the first embedding and the second embedding to from a weighted embedding in the embedding space. The method also includes predicting, by a trained classifier in response to the weighted embedding, a degree of empathy exhibited by the first user with respect to the second story according to the first story.

A non-transitory computer-readable medium having program code recorded thereon for empathy prediction using rater perspective is described. The program code is executed by a processor. The non-transitory computer-readable medium includes program code to encode a first story written by a first user regarding a selected topic to form a first embedding in an embedding space. The non-transitory computer-readable medium also includes program code to encode a second story written by a second user regarding the selected topic to form a second embedding in the embedding space. The non-transitory computer-readable medium further includes program code to weight the first embedding and the second embedding to from a weighted embedding in the embedding space. The non-transitory computer-readable medium also includes program code to predict, by a trained classifier in response to the weighted embedding, a degree of empathy exhibited by the first user with respect to the second story according to the first story.

A system for empathy prediction using rater perspective is described. The system includes a first story encoder to encode a first story written by a first user regarding a selected topic to form a first embedding in an embedding space. The system also includes a second story encoder to encode a second story written by a second user regarding the selected topic to form a second embedding in the embedding space. The system further includes an embedding space weighting model to weight the first embedding and the second embedding to from a weighted embedding in the embedding space. The system also includes a personal perspective empathy prediction (PPEP) model to predict, by a trained classifier in response to the weighted embedding, a degree of empathy exhibited by the first user with respect to the second story according to the first story.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of an empathy prediction system, according to aspects of the present disclosure.

FIG. 2 is a block diagram illustrating an exemplary software architecture that may modularize artificial intelligence (AI) functions for an empathy prediction system, according to aspects of the present disclosure.

FIG. 3 is a diagram illustrating a hardware implementation for an empathy prediction system, according to aspects of the present disclosure.

FIG. 4 is a block diagram illustrating a process for collecting an empathy from perspectives (EFP) dataset, according to various aspects of the present disclosure.

FIGS. 5A and 5B are histograms illustrating distribution of empathy values, according to various aspects of the present disclosure.

FIG. 6 is a block diagram illustrating a personal perspective empathy prediction (PPEP) model for computing a perspective empathy, according to various aspects of the present disclosure.

FIG. 7 is a flowchart illustrating a method for empathy prediction using rater perspective, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

From behavioral science, it is recognized that empathy is “the ability to recognize, understand, and share the thoughts and feelings of another person, animal, or fictional character.” Although methods for empathy prediction have been proposed, most prediction is performed assuming that empathy can be predicted without consideration of different perspectives. Often, an aggregate of empathy ratings are used. Unfortunately, people will react with different levels of empathy to a given text passage, based in part on their background and current context. In particular, behavioral science recognizes that people find it easier relating to people that are more similar to themselves based on a minimal psychological distance. Consequently, stories by others with diverging views about an issue may be ignored or brushed aside because they are substantially different from a reader's own perspective.

Models for empathy prediction are generally developed from data labeled by third parties. For some situations, prediction of the average empathy towards a story, such as a political event, may be desirable; however, for other situations, individual empathy views may be important. Some examples include when negotiating a compromise with a person or comparing different ways of telling a story in hopes of gaining empathy. For example, when the same “story” is rated for empathy by different people, they assign different empathy scores based on their personal context. For example, someone that was a crime victim may be more empathetic to another crime victim. Conventional solutions instead assume that the empathy of a story can be predicted independent of a person assigned to rate the story (“rater”). Other works explore the use of demographics of a story writer as additional input, with mixed results. None of the approaches considers using the story of a rater when predicting empathy, such as an empathetic resonance.

Various aspects of the present disclosure predict a person's empathy rating for another's idea. This can be useful when two people have divergent views to know how empathetic one or both are to another's ideas. For example, two people may wish to use the same space for different things, or one neighbor may want to build something right next to another's lot line. Some implementations of the present disclosure are utilized to rate the empathy for different possible ideas proposed by a mediator. Some implementations of the present disclosure are utilized in the ordering and selecting of a sequence of stories to try to slowly increase the empathy of one person for another's ideas.

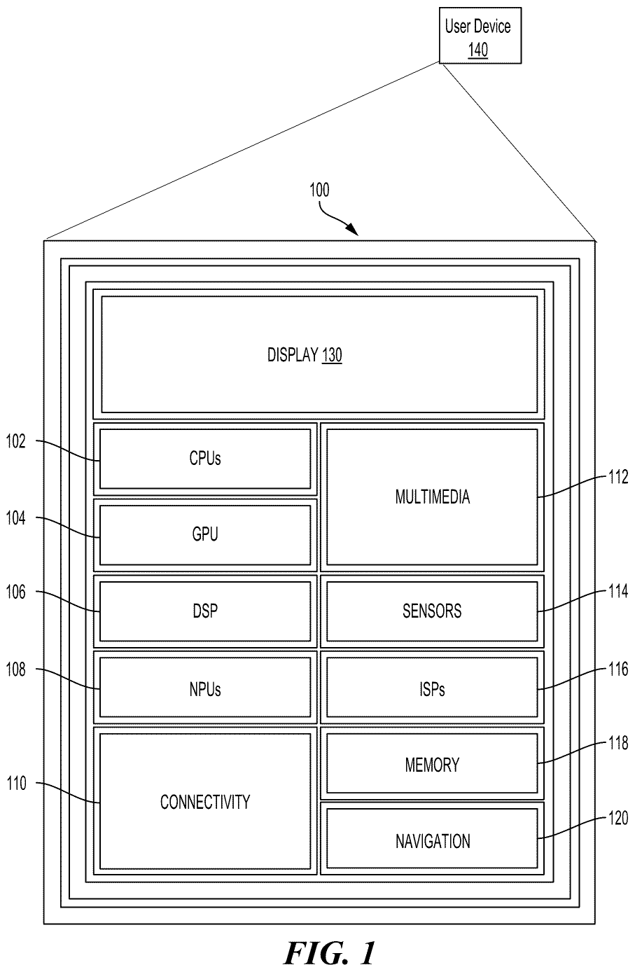

FIG. 1 illustrates an example implementation of the aforementioned system and method for an empathy prediction system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) cellular network technology, fifth generation (5G) new radio (NR) technology, fourth generation long term evolution (4G LTE) connectivity, unlicensed WiFi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with a user device 140. In this arrangement, the user device 140 may include a processor and other features of the SOC 100.

In various aspects of the present disclosure, instructions loaded into a processor (e.g., the CPU 102) or the NPU 108 of the user device 140 may include code to predict empathy of a user with respect to any idea. The instructions loaded into a processor (e.g., the NPU 108) may also include code to encode a first story written by a first user regarding a selected topic to form a first embedding in an embedding space. The instructions loaded into a processor (e.g., the NPU 108) may also include code to encode a second story written by a second user regarding the selected topic to form a second embedding in the embedding space. The instructions loaded into a processor (e.g., the NPU 108) may also include code to weight the first embedding and the second embedding to form a weighted embedding in the embedding space. The instructions loaded into a processor (e.g., the NPU 108) may also include code to predict a degree of empathy exhibited by the first user with respect to the second story according to the first story using a trained classifier in response to the weighted embedding.

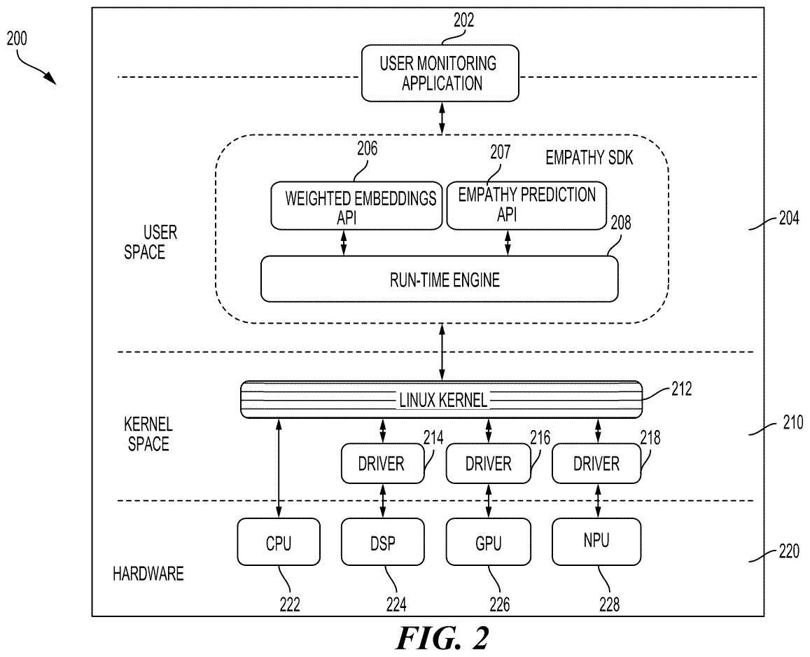

FIG. 2 is a block diagram illustrating a software architecture 200 that may modularize artificial intelligence (AI) functions for an empathy prediction system, according to aspects of the present disclosure. Using the software architecture 200, a user monitoring application 202 may be designed such that it may cause various processing blocks of a system-on-a-chip (SOC) 220 (for example a CPU 222, a DSP 224, a GPU 226, and/or an NPU 228) to perform supporting computations during run-time operation of the user monitoring application 202. FIG. 2 describes the software architecture 200 for the empathy prediction system, it should be recognized that the empathy prediction system is not limited to different stories. According to aspects of the present disclosure, the empathy prediction functionality is applicable to any type of user activity between different individuals, such as the young and the older generations.

The user monitoring application 202 may be configured to call functions defined in a user space 204 that may, for example, provide for empathy prediction. The user monitoring application 202 may make a request for compiled program code associated with a library defined in a weighted embeddings application programming interface (API) 206. The weighted embeddings API 206 is configured to encode a first story written by a first user regarding a selected topic to form a first embedding and to encode a second story written by a second user regarding the selected topic to form a second embedding in an embedding space. In addition, the compiled program code of the weighted embeddings API 206 is configured to weight the first embedding and the second embedding to form a weighted embedding in the embedding space. In response, the compiled program code of an empathy prediction API 207 is configured to predict a degree of empathy exhibited by the first user with respect to the second story according to the first story using a trained classifier in response to the weighted embedding.

A run-time engine 208, which may be compiled code of a run-time framework, may be further accessible to the user monitoring application 202. The user monitoring application 202 may cause the run-time engine 208, for example, to take actions for predicting an empathy of a first user regarding an idea of a second user based on a perspective determined for the first user. The run-time engine 208 may in turn send a signal to an operating system 210, such as a Linux Kernel 212, running on the SOC 220. FIG. 2 illustrates the Linux Kernel 212 as software architecture for empathy prediction based on user stories. It should be recognized, however, that aspects of the present disclosure are not limited to this exemplary software architecture. For example, other kernels may provide the software architecture to support the empathy prediction functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

Models for empathy prediction are generally developed from data labeled by third parties. For some situations, prediction of the average empathy towards a story, such as a political event, may be desirable; however, for other situations, individual empathy views may be important. Some examples include negotiating a compromise with a person or comparing different ways of telling a story in hopes of gaining empathy. For example, when the same “story” is rated for empathy by different people, they assign different empathy scores based on their personal context. For example, someone that was a crime victim may be more empathetic to another crime victim. Conventional solutions instead assume that the empathy of a story can be predicted independent of a person assigned to rate the story (“rater”). Other works explore the use of demographics of a story writer as additional input, with mixed results. None of the approaches considers using the story of a rater when predicting empathy.

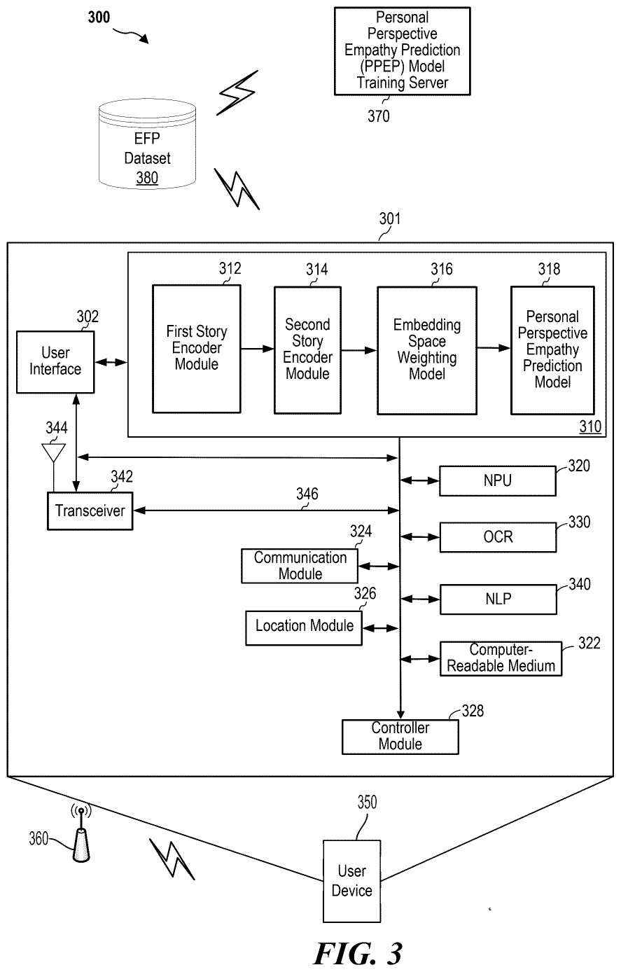

Various aspects of the present disclosure predict a person's empathy rating for another's idea. This can be useful when two people have divergent views to know how empathetic one or both are to another's ideas. For example, two people may wish to use the same space for different things, or one neighbor may want to build something right next to another's lot line. Some implementations of the present disclosure are utilized to rate the empathy for different possible ideas proposed by a mediator. Some implementations of the present disclosure are utilized in the ordering and selecting of a sequence of stories to try to slowly increase the empathy of one person for another's ideas. Empathy prediction may be performed, for example, as shown in FIG. 3.

FIG. 3 is a diagram illustrating a hardware implementation for an empathy prediction system 300, according to aspects of the present disclosure. The empathy prediction system 300 may be configured to predict user empathy regarding an idea based on a perspective determined for a user. The empathy prediction system 300 is configured to encode a first story written by a first user regarding a selected topic to form a first embedding and to encode a second story written by a second user regarding the selected topic to form a second embedding in an embedding space. In addition, the empathy prediction system 300 is configured to concatenate the first embedding and the second embedding to form a weighted embedding in the embedding space. In response, the empathy prediction system 300 is configured to predict a degree of empathy exhibited by the first user with respect to the second story according to the first story using a trained classifier in response to the weighted embedding.

The empathy prediction system 300 includes a user monitoring system 301 and a personal perspective empathy prediction (PPEP) model training server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The PPEP model training server 370 may connect to the user device 350 for generating a story generation from several users, in which a content of the stories indicates a writer's perspective. For example, the PPEP model training server 370 may train a PPEP model. In various aspects of the present disclosure, the PPEP model training server 370 trains the PPEP model to learn to predict the empathy of a person with respect to another person's idea. In other words, the PPEP model uses a rater's perspective as a basis for the empathy prediction.

The user monitoring system 301 may be implemented with an interconnected architecture, represented generally by an interconnect 346. The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neutral network processor (NPU) 320, a computer-readable medium 322, a communication module 324, a location module 326, a controller module 328, an optical character recognition (OCR) 330, and a natural language processor (NLP) 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the controller module 328, the OCR 330, and the NLP 340. The transceiver 342 is coupled to an antenna 344. The transceiver 342 communicates with various other devices over a transmission medium. For example, the transceiver 342 may receive commands via transmissions from a user or a connected vehicle. In this example, the transceiver 342 may receive/transmit information for the user activity module 310 to/from connected devices within the vicinity of the user device 350.

The user monitoring system 301 includes the NPU 320 coupled to the computer-readable medium 322. The NPU 320 performs processing, including the execution of software stored on the computer-readable medium 322 to provide a neural network model for user monitoring and advice recommendation functionality according to the present disclosure. The software, when executed by the NPU 320, causes the user monitoring system 301 to perform the various functions described for presenting a gradually modified digital avatar to the user through the user device 350, or any of the modules (e.g., 310, 324, 326, and/or 328). The computer-readable medium 322 may also be used for storing data that directs the OCR 330 when executing the software to analyze user stories, narratives, and perspectives.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the OCR 330 to analyze user stories to determine the narrative and/or perspective (e.g., a first perspective or a second perspective) of the writer of the story. From behavioral science, it is recognized that empathy is “the ability to recognize, understand, and share the thoughts and feelings of another person, animal, or fictional character.” Although methods for empathy prediction have been proposed, most prediction is performed assuming that empathy can be predicted without consideration of different perspectives. Often, an aggregate of empathy ratings are used. Unfortunately, people will react with different levels of empathy to a given text passage, based in part on their background and current context. Additionally, stories by others with diverging views about an issue may be ignored or brushed aside because they are substantially different from a reader's own perspective.

Models for empathy prediction are generally developed from data labeled by third parties. For some situations, prediction of the average empathy towards a story, such as a political event, may be desirable; however, for other situations, individual empathy views may be important. Some examples include when negotiating a compromise with a person or comparing different ways of telling a story in hopes of gaining empathy. For example, when the same “story” is rated for empathy by different people, they assign different empathy scores based on their personal context. For example, someone that was a crime victim may be more empathetic to another crime victim. Conventional solutions instead assume that the empathy of a story can be predicted independent of a person assigned to rate the story (“rater”). Other works explore the use of demographics of a story writer as additional input, with mixed results. None of the approaches considers using the story of a rater when predicting empathy.

As shown in FIG. 3, the user activity module 310 includes a first story encoder module 312, a second story encoder module 314, an embedding space weighting model 316, and a personal perspective empathy prediction (PPEP) model 318. The first story encoder module 312, the second story encoder module 314, the embedding space weighting model 316, and the PPEP model 318 may be components of a same or different artificial neural network, such as a multilayer perceptron (MLP) classifier.

This configuration of the user activity module 310 includes the first story encoder module 312 configured to encode a first story written by a first user regarding a selected topic to form a first embedding in an embedding space. The second story encoder module 314 is configured to encode a second story written by a second user regarding the selected topic to form a second embedding in the embedding space. In response, the embedding space weighting model 316 is configured to weight the first embedding and the second embedding to form a weighted embedding in the embedding space. In some implementations, the embedding space weighting model 316 is configured to weight the first embedding and the second embedding to form a weighted embedding in the embedding space. In this implementation, concatenation plus the fully connected layers is one type of weight. In some implementations, attention provides a method of combination. In this implementation, a cross-attention layer computes cross-attention between the first story embedding and the second story embedding as the weighted embedding.

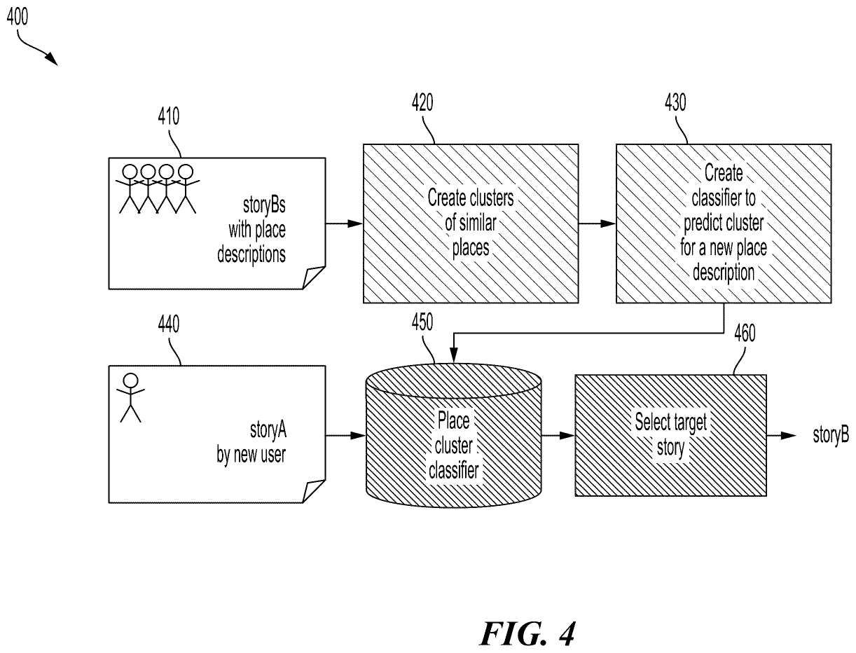

In various aspects of the present disclosure, the PPEP model 318 is configured to predict a degree of empathy exhibited by the first user with respect to the second story according to the first story using a trained classifier in response to the weighted embedding. In some aspects of the present disclosure, the user activity module 310 may be implemented and/or work in conjunction with the PPEP model training server 370 and an empathy from perspectives (EFP) dataset 380. In some implementations, the EFP dataset 380 is generated, for example, as shown in FIG. 4.

FIG. 4 is a block diagram illustrating a process 400 for collecting an empathy from perspectives (EFP) dataset, according to various aspects of the present disclosure. In some implementations, an EFP dataset is collected in two stages. In a first stage, a first set of subjects are recruited, for example, from a first research site to provide feedback at block 410. As described, a person that rates their empathy for another's story is referred to as PersonA, and the person whose story is rated is referred to as PersonB.

In some implementations, PersonA and PersonB each write a “story” about a topic of their choosing, in which PersonA's story is referred to as storyA and PersonB's story will be called storyB. In this example, to collect storyBs at block 410, each subject, personB, is asked to name and describe a place that made them feel either safe, welcome, unsafe, or excluded. They were then asked why they felt that way. Finally, they asked how they would modify a safe or unsafe place to be safer or how they would modify a welcoming or excluding place to be more welcoming. For example, both may write about how they would like to modify a park.

As shown at block 410 of FIG. 4, storyBs are provided with place descriptions. At block 420, storyBs having a similar type of place are clustered using, for example, agglomerative clustering. In this implementation, embeddings representing places are clustered and the clusters recorded. In some examples, a known clustering function or classification function may be used to produce the clusters. For example, agglomerative clustering with Ward linkage may be used to generate clusters, where one cluster may be associated with restaurants, another cluster associated with religious institutions, and still another cluster associated with residential housing. At block 430, a classifier is trained to predict a cluster from a new place description in the storyBs, such as a library.

As shown in FIG. 4, the process 400 for collecting the EFP dataset may be utilized to identify stories for which there may be different perspectives. As shown in block 410 identified stories regarding a same type of place are clustered (e.g., using agglomerative clustering). Additionally, storyBs directed to safe and unsafe places were clustered together, and storyBs directed to the welcoming and excluding places were clustered together.

As further illustrated in FIG. 4, after a predetermined period of time (e.g., a year later) a second set of subjects is recruited to provide feedback for a second stage. For example, to obtain empathy ratings from divergent perspectives, a second set of participants are recruited from a second research site. As shown at block 440, the new participant, PersonA, is asked to write a story, storyA, about a place that felt either welcoming or safe to them, using the same prompts used to collect the storyBs at block 410. Next, a place cluster classifier 450 identifies the type of place written about and the one or more stories (e.g., storyB) for PersonA to rate are selected at block 460.

In various aspects of the present disclosure, generation of the place cluster classifier 450 may include training a neural network based on the place descriptions and stories (e.g., block 410), place clusters (e.g., block 420), and embedded features. In some examples, a classification model may be trained to classify new place descriptions. For example, the place descriptions may be given labels such as “restaurant” or “religious institution.” The labels may be associated with the clusters generated by the place cluster classifier 450. The model may then be trained based on the labeled dataset of place descriptions. Once trained, the place cluster classifier 450 may implement the model to predict the cluster of a new place description.

In this example, welcoming stories are matched to excluding stories and safe stories are matched to less safe stories. According to the process 400, PersonA provides a rating of their empathy for one, three, or five storyBs, with an equal number of PersonAs assigned to each condition. Additionally, PersonA is asked if they identified with storyB, and some were asked for demographics. In this implementation, the EFP dataset is composed of pairs of storyA and each storyB selected based on PersonA's storyA, together with the empathy rating of PersonA towards storyB, as shown in Table I.

TABLE I
EFP Datasets

| dataset | # ratings | # personA | # personB | # storyA | # storyB | description |
|---|---|---|---|---|---|---|
| EFP | 3237 | 1854 | 387 | 1853 | 573 | empathy of A towards storyB |
| EFP_{B} | 3237 | 1854 | 387 | 0 | 573 | EFP without storyA |
| EFP_{demog} | 1925 | 1223 | 344 | 1234 | 488 | Subset of EFP containing |
| ES | 2000 | — | — | | — | demog from (Shen et al., |
| | | | | | | 2023) |

Table I illustrates various empathy from perspectives (EFP) datasets used in experiments, according to various aspects of the present disclosure. As shown in Table I, the first row corresponds to an EFP data regarding empathy of PersonA towards storyB. The second row of Table I illustrates an EFPB, which is composed of the EFP data of the first row, in which story A has been removed. The third row of Table I illustrates an EFPdemog dataset as a subset of the EFP dataset of the first row, for which demographic information is collected. The fourth row of Table I illustrates an ES dataset (i.e., EmpatheticStories from Shen et al., 2023), which used third-person annotation of empathic similarity. As shown in Table I, the EFP ratings are first-person empathy ratings for another person's story.

Table I shows statistics of the story pairs and empathy ratings for the EFP dataset and different subsets of the EFP data. The dataset was split 75/5/20 into train, development, and test sets and fixed for all experiments. Also shown is the EmpathicStories dataset, which was used in some experiments. In Table 1, the number of StoryB empathy ratings is the same as that of EFP, capturing that different people will assign different empathy ratings to the same story. The EFP demog dataset is used to evaluate the usefulness of demographics.

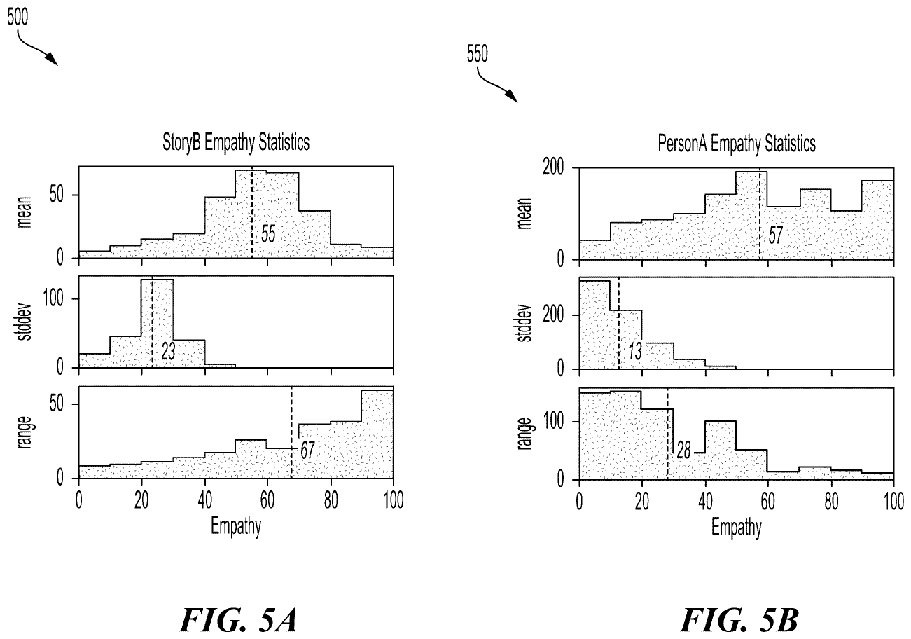

FIGS. 5A and 5B are histograms illustrating distribution of empathy values, according to various aspects of the present disclosure. FIG. 5A illustrates a first histogram 500, showing a distribution of empathy values that users assigned to the set of storyBs in a training dataset when at least two ratings are given to a story. In this example, a mean value of empathy assigned to a story was fifty-five (55), while the mean of the standard deviation of empathy values per story was twenty-three (23). Additionally, the range of values assigned to each storyB varied from about one (1) to one hundred (100), with a mean range of sixty-seven (67), indicating that for the stories in the training dataset, people often assign very different empathy values, and a single empathy value may not be very meaningful.

FIG. 5B illustrates a second histogram 550, showing personA empathy rating statistic, according to various aspects of the present disclosure. FIG. 5B illustrates the distribution of empathy values by each personA who rated their empathy towards at least two stories for the training dataset. Although the mean empathy value assigned by a person who rated at least two stories varied over the full range, the mean of the standard deviations of personA ratings was thirteen (13). Consequently, the variation of empathy scores assigned by a person tended to vary less than the variation of scores assigned to a storyB, as shown in FIG. 5A. This was also reflected in the larger range of empathy values assigned to storyB than the range of empathy values individuals (personAs) assigned to stories. These observations indicate that information about personA when trying to predict personA's empathy for a story might be helpful.

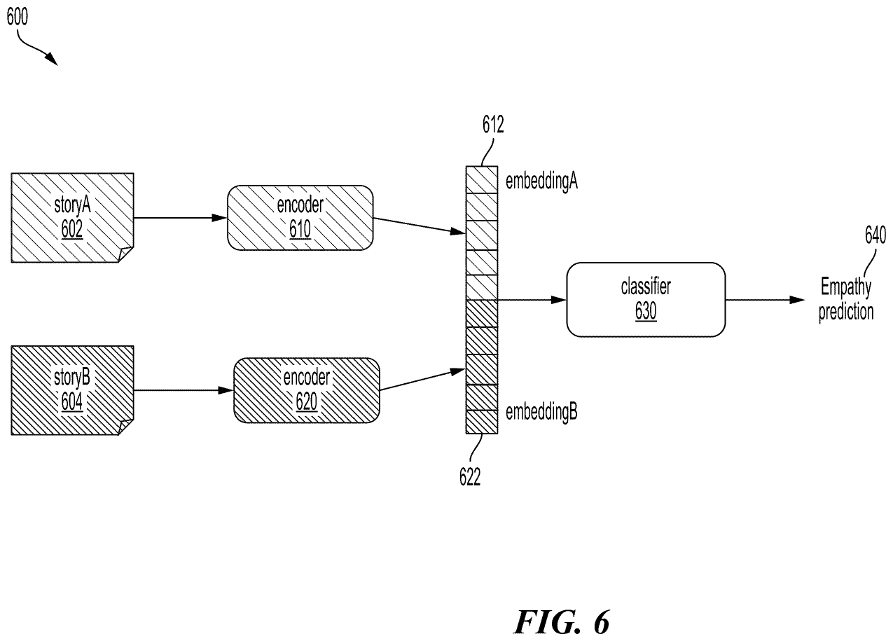

FIG. 6 is a block diagram illustrating a personal perspective empathy prediction (PPEP) model 600 for computing a perspective empathy, according to various aspects of the present disclosure. In some implementations, the PPEP model 600 utilizes a classification model. Classification models may be used to predict categorical outcomes by learning patterns and relationships within labeled datasets. These models analyze input features and assign them to classes or categories. Classification models operate by discerning decision boundaries in the data space, effectively mapping input features to the most probable class label. The purpose of classification models is to generalize from the provided training data to accurately classify new, unseen instances. In this implementation, the PPEP model 600 is configured as a multilayer perceptron (MLP)-based PPEP model. For example, a classifier 630 of the PPEP model 600 is configured as a three-layer MLP classifier.

As shown in the FIG. 6, a storyA 602 is input to a first encoder 610, which generates a first embedding of storyA 602, creating an embeddingA 612. Similarly, a storyB 604 is input to a second encoder 620, which generates a second embedding of storyB 604, creating an embeddingB 622. In this example, the first encoder 610 and the second encoder 620 utilize feature embedding to create the embeddingA 612 and the embeddingB 622. In some implementations, demographics of a story writer as well as a different story parts are provided as additional inputs to the first encoder 610 and/or the second encoder 620.

Feature embedding refers to the process of transforming high-dimensional data into a lower-dimensional space while preserving essential information. In machine learning, feature embedding converts categorical or numerical features into a more compact and meaningful representation, facilitating better model understanding and performance. By mapping each original feature to a continuous vector space, embeddings capture relationships, similarities, and contextual information between different features or items. Feature embedding is commonly used in natural language processing (NLP), where words or phrases are converted into fixed-size vectors, enabling models to understand semantic relationships and contexts, thus enhancing the performance of tasks like language translation, sentiment analysis, and document classification.

As shown in FIG. 6, the embeddingA 612 and the embeddingB 622 are weighted to form a weighted embedding that is fed into the classifier 630. In this implementation, the classifier 630 is a three (3)-layer MLP classifier, in which a size of each layer is progressively reduced, and a final layer output is input to a sigmoid. In various aspects of the present disclosure, the sigmoid is configured to generate an empathy prediction 640, in which the empathy prediction 640 represents a predicted empathy of a personA towards the storyB 604. In this implementation, the PPEP model 600 is trained with a rater's story as storyA and the story to be rated is always storyB, so that the PPEP model 600 learns to predict the empathy of storyB with respect to storyA by utilizing a rater perspective.

In some implementations, the PPEP model 600 is configured to weight the embeddingA 612 and the embeddingB 622 the second embedding to form a weighted embedding that is fed into the classifier 630. In some implementations, concatenation plus the fully connected layers from the classifier 630 represents one type of weight. In some implementations, attention provides a method of combination. In this implementation, a cross-attention layer computes cross-attention between the first story embedding and the second story embedding as the weighted embedding that is fed into the classifier 630.

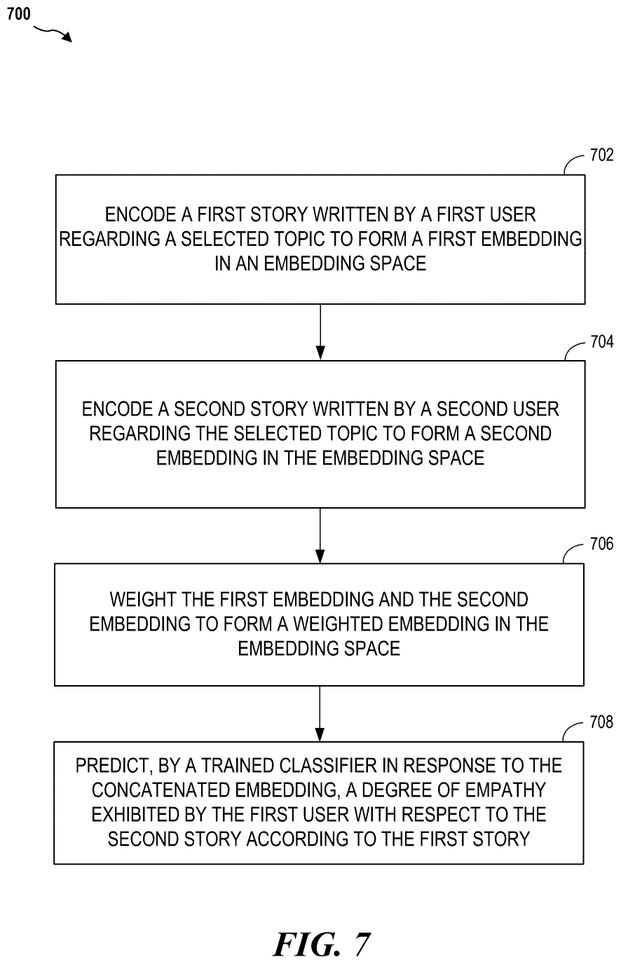

Various aspects of the present disclosure recognize that user perspectives are important for empathy prediction when there are diverse perspectives. The PPEP model 600 showed that modeling user perspective (storyA) as context was more effective for empathy prediction than modeling the similarity of two stories. While prediction of absolute empathy is difficult, structuring the training data to also include examples of relative empathy between stories allowed the PPEP model 600 to also learn to predict relative empathy, because the PPEP model 600 rating of stories generally agreed with a human empathy rating. A process for empathy prediction using rater perspective is shown, for example, in FIG. 7.

FIG. 7 is a flowchart illustrating a method 700 for empathy prediction using rater perspective, according to aspects of the present disclosure. The method 700 begins at block 702, in which a first story written by a first user regarding a selected topic is encoded to form a first embedding in an embedding space. At block 704, a second story written by a second user regarding the selected topic is encoded to form a second embedding in the embedding space. For example, as shown in FIG. 6, a storyA 602 is input to a first encoder 610, which generates a first embedding of storyA 602, creating an embeddingA 612. Similarly, a storyB 604 is input to a second encoder 620, which generates a second embedding of storyB 604, creating an embeddingB 622. In this example, the first encoder 610 and the second encoder 620 utilize feature embedding to create the embeddingA 612 and the embeddingB 622.

At block 706, the first embedding and the second embedding are weighted to from a weighted embedding in the embedding space. For example, as shown in FIG. 6, the PPEP model 600 is configured to weight the embeddingA 612 and the embeddingB 622 the second embedding to form a weighted embedding that is fed into the classifier 630. In some implementations, concatenation plus the fully connected layers from the classifier 630 represents one type of weight. In some implementations, attention provides a method of combination. In this implementation, a cross-attention layer computes cross-attention between the first story embedding and the second story embedding as the weighted embedding that is fed into the classifier 630.

At block 708, a trained classifier predicts a degree of empathy exhibited by the first user with respect to the second story according to the first story in response to the weighted embedding. For example, as shown in FIG. 6, the embeddingA 612 and the embeddingB 622 are weighted to form a weighted embedding that is fed into the classifier 630. In this implementation, the classifier 630 is a three (3)-layer MLP classifier, in which a size of each layer is progressively reduced, and a final layer output is input to a sigmoid. In various aspects of the present disclosure, the sigmoid is configured to generate an empathy prediction 640, in which the empathy prediction 640 represents a predicted empathy of a personA towards the storyB 604. In this implementation, the PPEP model 600 is trained with a rater's story as storyA and the story to be rated is always storyB, so that the PPEP model 600 learns to predict the empathy of storyB with respect to storyA by utilizing a rater perspective.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for empathy prediction using rater perspective, comprising:
encoding a first story written by a first user regarding a selected topic to form a first embedding in an embedding space;
encoding a second story written by a second user regarding the selected topic to form a second embedding in the embedding space;
weighting the first embedding and the second embedding to form a weighted embedding in the embedding space; and
predicting, by a trained classifier in response to the weighted embedding, a degree of empathy exhibited by the first user with respect to the second story according to the first story.

2. The method of claim 1, in which predicting the degree of empathy comprises inferring an empathetic resonance of the first user with respect to the second story according to a narrative of the first story.

3. The method of claim 1, in which predicting the degree of empathy comprises:
analyzing a narrative of the first story written by the first user regarding the selected topic;
determining a perspective of the first user according to the narrative of the first story relative to a narrative of the second story; and
inferring the degree of empathy exhibited by the first user regarding the second story according to the perspective of the first user.

4. The method of claim 1, in which inferring comprises:
determining a first perspective of the first story;
determining a second perspective of the second story,
determining whether the first perspective is compatible with the second perspective; and
inferring the degree of empathy exhibited by the first user regarding the second story according to the determining.

5. The method of claim 1, in which predicting comprises:
feeding the weighted embedding to the trained classifier;
inputting a final layer output of the trained classifier to a sigmoid; and
outputting, by the sigmoid, a predicted empathy of the first user to the second story.

6. The method of claim 5, in which the trained classifier comprises a multilayer perceptron (MLP) classifier, and the predicted empathy comprises an empathy rating of the first user with respect to an idea of the second story.

7. The method of claim 1, in which weighting comprises computing cross-attention between the first embedding and the second embedding to form a cross-attention embedding as the weighted embedding in the embedding space.

8. The method of claim 1, in which weighting comprises concatenating the first embedding and the second embedding to form a concatenated embedding as the weighted embedding in the embedding space.

9. A non-transitory computer-readable medium having program code recorded thereon for empathy prediction using rater perspective, the program code being executed by a processor and comprising:
program code to encode a first story written by a first user regarding a selected topic to form a first embedding in an embedding space;
program code to encode a second story written by a second user regarding the selected topic to form a second embedding in the embedding space;
program code to weight the first embedding and the second embedding to from a weighted embedding in the embedding space; and
program code to predict, by a trained classifier in response to the weighted embedding, a degree of empathy exhibited by the first user with respect to the second story according to the first story.

10. The non-transitory computer-readable medium of claim 9, in which the program code to predict the degree of empathy comprises program code to infer an empathetic resonance of the first user with respect to the second story according to a narrative of the first story.

11. The non-transitory computer-readable medium of claim 9, in which the program code to predict the degree of empathy comprises:
program code to analyze a narrative of the first story written by the first user regarding the selected topic;
program code to determine a perspective of the first user according to the narrative of the first story relative to a narrative of the second story; and
program code to infer the degree of empathy exhibited by the first user regarding the second story according to the perspective of the first user.

12. The non-transitory computer-readable medium of claim 9, in which the program code to infer comprises:
program code to determine a first perspective of the first story;
program code to determine a second perspective of the second story,
program code to determine whether the first perspective is compatible with the second perspective; and
program code to infer the degree of empathy exhibited by the first user regarding the second story according to the determining.

13. The non-transitory computer-readable medium of claim 9, in which the program code to predict comprises:
program code to feed the weighted embedding to the trained classifier;
program code to input a final layer output of the trained classifier to a sigmoid; and
program code to output, by the sigmoid, a predicted empathy of the first user to the second story.

14. The non-transitory computer-readable medium of claim 13, in which the trained classifier comprises a multilayer perceptron (MLP) classifier, and in which the predicted empathy comprises an empathy rating of the first user with respect to an idea of the second story.

15. The non-transitory computer-readable medium of claim 9, in which the program code to weight comprises program code to compute cross-attention between the first embedding and the second embedding to form a cross-attention embedding as the weighted embedding in the embedding space.

16. The non-transitory computer-readable medium of claim 9, in which the program code to weight comprises program code to concatenate the first embedding and the second embedding to form a concatenated embedding as the weighted embedding in the embedding space.

17. A system for empathy prediction using rater perspective, the system comprising:
a first story encoder to encode a first story written by a first user regarding a selected topic to form a first embedding in an embedding space;
a second story encoder to encode a second story written by a second user regarding the selected topic to form a second embedding in the embedding space;
an embedding space weighting model to weight the first embedding and the second embedding to from a weighted embedding in the embedding space; and
a personal perspective empathy prediction (PPEP) model to predict, by a trained classifier in response to the weighted embedding, a degree of empathy exhibited by the first user with respect to the second story according to the first story.

18. The system of claim 17, in which the personal perspective empathy prediction model is further to infer an empathetic resonance of the first user with respect to the second story according to a narrative of the first story.

19. The system of claim 17, in which the personal perspective empathy prediction model is further to feed the weighted embedding to the trained classifier, to input a final layer output of the trained classifier to a sigmoid, and to output, by the sigmoid, a predicted empathy of the first user to the second story.

20. The system of claim 19, in which the trained classifier comprises a multilayer perceptron (MLP) classifier.
